(19) United States
(12) Patent Application Publication
(10) Pub. No.: US 2026/0194449 A1
(43) Pub. Date: Jul. 9, 2026

(54) GAS SENSING DEVICE AND PHOTOACOUSTIC SPECTROSCOPY GAS SENSOR

(71) Applicant: ZILLTEK TECHNOLOGY CORP., Hsinchu City (TW)

(72) Inventors: JEN-YI CHEN, Hsinchu City (TW); KAI-YU JIANG, Hsinchu City (TW)

(21) Appl. No.: 19/010,204

(22) Filed: Jan. 6, 2025

(51) Int. Cl. G01N 21/17

(52) U.S. Cl. CPC G01N 21/1702; G01N 2021/1704

(57) ABSTRACT

A gas sensing device and a photoacoustic spectroscopy gas sensor. The gas sensing device includes an emitter and a photoacoustic spectroscopy gas sensor. The emitter can emit a predetermined electromagnetic wave. The photoacoustic spectroscopy gas sensor is disposed at one side of the emitter and includes a reaction chamber, an accommodation chamber, a microelectromechanical system unit, and an application-specific integrated circuit. The reaction chamber has a reaction space for accommodating a gas. The predetermined electromagnetic wave can pass through the reaction chamber and enter into the reaction space, such that the gas and the predetermined electromagnetic wave generate a sound wave to be tested. The accommodation chamber is connected to the reaction chamber and has an accommodation space. The accommodation chamber and the reaction jointly have a sound channel. The microelectromechanical system unit is disposed in the accommodation chamber and covers the sound channel.

### FIELD OF THE DISCLOSURE

The present disclosure relates to a sensing device, and more particularly to a gas sensing device and photoacoustic spectroscopy gas sensor.

### BACKGROUND OF THE DISCLOSURE

A conventional gas sensing device is configured to utilize a photoacoustic effect to test a gas. A work principle of the conventional gas sensing device is that, after a gas absorbs light having a specific wavelength (hereinafter referred to as “sound wave to be tested”), the gas molecules of the sound wave to be tested generate a sound wave because of thermal expansion. Accordingly, the conventional gas sensing device tests the sound wave to be tested to identify the existence of the gas and the concentration thereof.

However, in a conventional gas sensing device, a distance between a position where the gas is emitted and a position of a sensor is relatively far. In other words, a path that the sound wave to be tested needs to take to reach the sensor is too far, such that the conventional gas sensing device can have issues relating to measurement errors and slow sensing speed. In addition, a reaction chamber of the conventional gas sensing device is too large, such that a time period that the gas takes to enter the reaction chamber and achieving an equilibrium concentration is too long, thereby also causing the issues relating to measurement errors and slow sensing speed.

### SUMMARY OF THE DISCLOSURE

In response to the above-referenced technical inadequacies, the present disclosure provides a gas sensing device.

In order to solve the above-mentioned problems, one of the technical aspects adopted by the present disclosure is to provide a gas sensing device. The gas sensing device includes an emitter and a photoacoustic spectroscopy gas sensor. The emitter is configured to emit a predetermined electromagnetic wave. The photoacoustic spectroscopy gas sensor is disposed at one side of the emitter, and the photoacoustic spectroscopy gas sensor includes a reaction chamber, an accommodation chamber, a microelectromechanical system unit, and an application-specific integrated circuit. The reaction chamber has a reaction space configured to accommodate a gas. The predetermined electromagnetic wave is configured to pass through the reaction chamber and enter into the reaction space, such that the gas and the predetermined electromagnetic wave generate a sound wave to be tested. The accommodation chamber is connected to the reaction chamber. The accommodation chamber has an accommodation space, the accommodation chamber and the reaction chamber jointly have a sound channel, and the sound channel is in spatial communication with the accommodation space and the reaction space. The microelectromechanical system unit is disposed in the accommodation chamber and covers the sound channel, such that the sound wave to be tested is configured to be directly tested by the microelectromechanical system unit. The application-specific integrated circuit is connected to the microelectromechanical system unit.

In order to solve the above-mentioned problems, another one of the technical aspects adopted by the present disclosure is to provide a photoacoustic spectroscopy gas sensor. The photoacoustic spectroscopy gas sensor includes a reaction chamber, an accommodation chamber, a microelectromechanical system unit, and an application-specific integrated circuit. The reaction chamber has a reaction space configured to accommodate a gas. A predetermined electromagnetic wave is configured to pass through the reaction chamber and enter into the reaction space, such that the gas and the predetermined electromagnetic wave generate a sound wave to be tested. The accommodation chamber is connected to the reaction chamber. The accommodation chamber has an accommodation space, the accommodation chamber and the reaction chamber jointly have a sound channel, and the sound channel is in spatial communication with the accommodation space and the reaction space. The microelectromechanical system unit is disposed in the accommodation chamber and covers the sound channel, such that the sound wave to be tested is configured to be directly tested by the microelectromechanical system unit. The application-specific integrated circuit is connected to the microelectromechanical system unit.

Therefore, in the gas sensing device and photoacoustic spectroscopy gas sensor provided by the present disclosure, by the design of “the accommodation chamber and the reaction chamber jointly having the sound channel that is in spatial communication with the accommodation space and the reaction space” and “the microelectromechanical system unit being disposed in the accommodation chamber and covering the sound channel, such that the sound wave to be tested is configured to be directly tested by the microelectromechanical system unit,” the gas sensing device and photoacoustic spectroscopy gas sensor can timely and accurately test the sound wave to be tested.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic planar view of a gas sensing device according to a first embodiment of the present disclosure;

FIG. 2 is a schematic planar view of a gas sensing device according to a second embodiment of the present disclosure;

FIG. 3 is a schematic planar view of a gas sensing device according to a third embodiment of the present disclosure;

FIG. 4 is a schematic planar view of a gas sensing device according to a fourth embodiment of the present disclosure;

FIG. 5 is a schematic planar view of a gas sensing device according to a fifth embodiment of the present disclosure; and

FIG. 6 is a schematic planar view of a gas sensing device according to a sixth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### FIRST EMBODIMENT

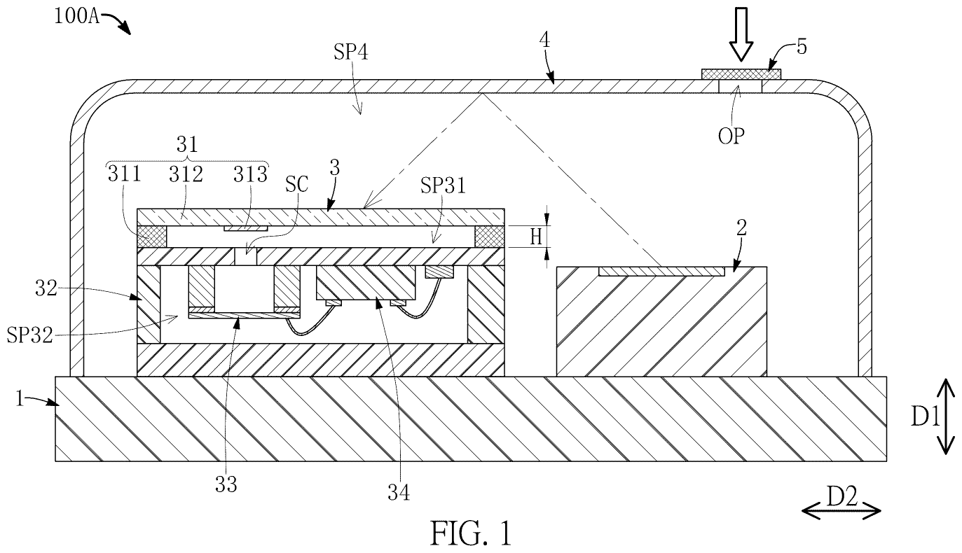

Referring to FIG. 1, an embodiment of the present disclosure provides a gas sensing device 100A, the gas sensing device 100A includes a carrier board 1, an emitter 2 disposed on the carrier board 1, a photoacoustic spectroscopy gas sensor 3 disposed on the carrier board 1 and arranged at one side of the emitter 2, a reflective cover 4 disposed on the carrier board 1 and covering the emitter 2 and the photoacoustic spectroscopy gas sensor 3, and an air-permeable dustproof mesh 5 disposed on the reflective cover 4.

It should be noted that, the carrier board 1, the emitter 2, the photoacoustic spectroscopy gas sensor 3, the reflective cover 4, and air-permeable dustproof mesh 5 mentioned above in the present embodiment can be jointly defined as the gas sensing device 100A, but the present disclosure is not limited thereto. For example, the photoacoustic spectroscopy gas sensor 3 can also be independently used (e.g., implemented, manufactured, or sold) or used in cooperation with other components. Each of the components of the gas sensing device 100A is described as follows, and the configuration between the components of the gas sensing device 100A will be described at appropriate parts of the disclosure.

Referring to FIG. 1, the carrier board 1 in the present embodiment can be a printed circuit board, and the carrier board 1 includes two width surfaces opposite to each other and an annular side surface connected to the two width surfaces. The carrier board 1 defines a height direction D1 and a width direction D2. The height direction D1 is defined as a direction extending from any one of the width surfaces to another one of the width surfaces, the width direction is defined as an extending direction of any one of the width surfaces, and the width direction D2 is perpendicular to the height direction D1. For the ease of the following description, one of the width surfaces is defined as a mounting surface (not labeled in the figures).

Referring to FIG. 1, the emitter 2 is disposed on the mounting surface, the emitter 2 is configured to emit a predetermined electromagnetic wave to a gas, such that the gas and the predetermined electromagnetic wave generate a sound wave to be tested. The predetermined electromagnetic wave can be visible light or invisible light.

In the present embodiment, a wavelength of the predetermined electromagnetic wave is preferably 4.26 μm, and a frequency of the predetermined electromagnetic wave is preferably between 10 Hz and 200 Hz, but the present disclosure is not limited thereto. In a practical application, the wavelength and the frequency of the predetermined electromagnetic wave can be adjusted according to the type of the gas to be tested.

Referring to FIG. 1, the photoacoustic spectroscopy gas sensor 3 is configured to accommodate the gas and is configured to receive the predetermined electromagnetic wave, such that the gas molecules of the gas generate the sound wave to be tested through interacting with the predetermined electromagnetic wave. At the same time, the photoacoustic spectroscopy gas sensor 3 can immediately test the sound wave to be tested when the sound wave to be tested is generated.

Specifically, the photoacoustic spectroscopy gas sensor 3 includes a reaction chamber 31, an accommodation chamber 32, a microelectromechanical system unit 33, and an application-specific integrated circuit 34. The accommodation chamber 32 is disposed on the mounting surface, and the reaction chamber 31 is disposed on one side surface of the accommodation chamber 32 away from the carrier board 1. In other words, the reaction chamber 31 and the accommodation chamber 32 are disposed along the height direction D1. The accommodation chamber 32 has an accommodation space SP32, and the microelectromechanical system unit 33 and the application-specific integrated circuit 34 are disposed in the accommodation space SP32.

In addition, the reaction chamber 31 is connected to the accommodation chamber 32, and the reaction chamber 31 has a reaction space SP31 for (temporarily) accommodating the gas. The predetermined electromagnetic wave can pass through the reaction chamber 31 and enter into the reaction space SP31, such that the gas and the predetermined electromagnetic wave generate the sound wave to be tested.

It should be noted that, the accommodation chamber 32 and the reaction chamber 31 jointly have a sound channel SC. In other words, the sound channel SC is in spatial communication with the accommodation space SP32 and the reaction space SP31. The microelectromechanical system unit 33 covers the sound channel SC, such that the sound wave to be tested can be directly tested by the microelectromechanical system unit 33.

In a practical application, the reaction chamber 31 includes a surrounding wall 311 and a light-transmittable cover 312. The surrounding wall 311 is made of an air-permeable material, and the light-transmittable cover 312 can be made of a material that the predetermined electromagnetic wave can pass through. The surrounding wall 311 is disposed on the accommodation chamber 32 and is covered by the light-transmittable cover 312 (i.e., the light-transmittable cover 312 is disposed on the surrounding wall 311), such that the surrounding wall 311 and the light-transmittable cover 312 can be in cooperation with one side surface of the accommodation chamber 32 facing toward the reaction chamber 31 to jointly define the reaction space SP31. In other words, the surrounding wall 311 is permeable for the gas to first enter into the reaction space SP31, and then be emitted by the predetermined electromagnetic wave.

Preferably, a minimum predetermined gap H is defined between the light-transmittable cover 312 and one side surface of the accommodation chamber 32 facing toward the light-transmittable cover 312, and the minimum predetermined gap H is between 0.1 mm and 1 mm, but the present disclosure is not limited thereto.

In addition, the light-transmittable cover 312 can include a material structure or a stack for absorbing a specific wavelength, so that the light-transmittable cover 312 can absorb the gas according to the wavelength thereof.

Referring to FIG. 1, the reflective cover 4 is disposed on the mounting surface of the carrier board 1, and the reflective cover 4 can be in cooperation with the carrier board 1 to form an enclosed space SP4. In other words, the emitter 2 and the photoacoustic spectroscopy gas sensor 3 are covered by the reflective cover 4 and arranged in the enclosed space SP4. An inner surface of the reflective cover 4 can reflect the predetermined electromagnetic wave emitted by the emitter 2, such that the predetermined electromagnetic wave passes through the light-transmittable cover 312 after being reflected.

However, the predetermined electromagnetic wave reflected by the reflective cover 4 is likely to pass through the sound channel SC and be emitted onto the microelectromechanical system unit 33, thereby causing the inaccurate measurement of the photoacoustic spectroscopy gas sensor 3. Thus, the reaction chamber 1 can further include an electromagnetic wave mask 313. Specifically, one side surface of the light-transmittable cover 312 facing toward the accommodation chamber 32 can have a predetermined region (not labeled in the figures), the predetermined region is located at an orthographic projection path formed by orthographically projecting the sound channel SC along the height direction D1, and the electromagnetic wave mask 313 is arranged in the predetermined region, such that, through the electromagnetic wave mask 313, the microelectromechanical system unit 33 can shield the predetermined electromagnetic wave that passes through the sound channel SC.

Preferably, a projection region formed by orthographically projecting the electromagnetic wave mask 313 along the height direction D1 onto the accommodation chamber 32 covers the sound channel SC. For example, an area of the electromagnetic wave mask 313 is greater than an area of the sound channel SC, such that the sound channel SC is covered by electromagnetic wave mask 313 along the height direction D1.

Referring to FIG. 1, in the present embodiment, one side of the reflective cover 4 away from the photoacoustic spectroscopy gas sensor 3 further has an opening OP for being filled with the gas, and the opening OP is covered by the air-permeable dustproof mesh 5, so as to ensure that the gas can enter into an inner side of reflective cover 4 from an outer side of the reflective cover 4.

In other words, the gas passes through the air-permeable dustproof mesh 5 and enters into the reflective cover 4, such that the gas passes through the surrounding wall 311 made of the air-permeable material and enters into the reaction space SP31 in a diffusion manner. In this way, when the gas in the reaction chamber SP31 is emitted by the predetermined electromagnetic wave, the sound wave to be tested is generated and is directly tested by the microelectromechanical system unit 33 arranged on the sound channel SC.

In a practical application, the surrounding wall 311 can be made of the air-permeable material that is configured to block sound waves, so as to prevent the sound wave to be tested from escaping out of the photoacoustic spectroscopy gas sensor 3, or to prevent the photoacoustic spectroscopy gas sensor 3 from being affected by external sound waves.

It should be noted that, in the present embodiment, the application-specific integrated circuit 34 is connected to the microelectromechanical system unit 33, and the application-specific integrated circuit 34 is configured to be in cooperation with the microelectromechanical system unit 33 to achieve the photoacoustic spectroscopy sensing technique. The above-mentioned technique is conventional and is not the focus of the present disclosure, and will not be reiterated herein.

### SECOND EMBODIMENT

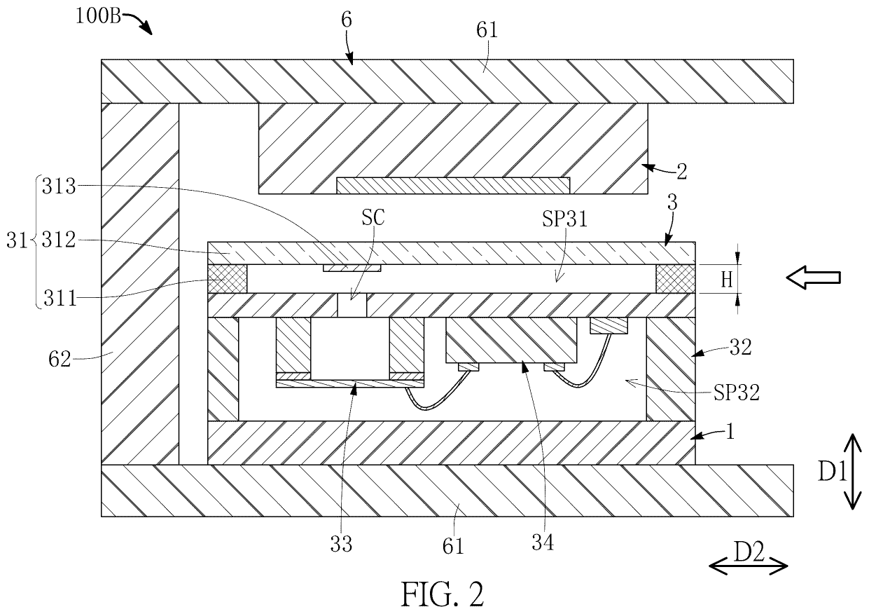

Referring to FIG. 2, a gas sensing device 100B of another embodiment of the present disclosure is similar to the gas sensing device 100A of the first embodiment, the same parts of the two embodiments will not be reiterated herein, and the main difference between the two embodiments is that the gas sensing device 100B of the present embodiment is provided without the carrier board 1, the reflective cover 4, and the air-permeable dustproof mesh 5, and the gas sensing device B includes a bracket 6.

Specifically, the bracket 6 in the present embodiment is in a shape of the letter “C” and has two horizontal portions 61 and a vertical portion 62 connected to the two horizontal portions 61. Two side surfaces of the horizontal surfaces 61 facing toward each other are respectively defined as two arrangement surfaces (not labeled in the figures), and the emitter 2 and the photoacoustic spectroscopy gas sensor 3 are respectively disposed at the two arrangement surfaces, such that the predetermined electromagnetic wave emitted by the emitter 2 is configured to directly pass through the light-transmittable cover 312. In other words, in the present embodiment, a path of the predetermined electromagnetic wave directly passes through the light-transmittable cover 312.

In addition, the bracket 6 of the present embodiment has an opening space. In other words, the gas directly passes through the surrounding wall 311 made of the gas-permeable material and enters into the reaction space SP31.

### THIRD EMBODIMENT

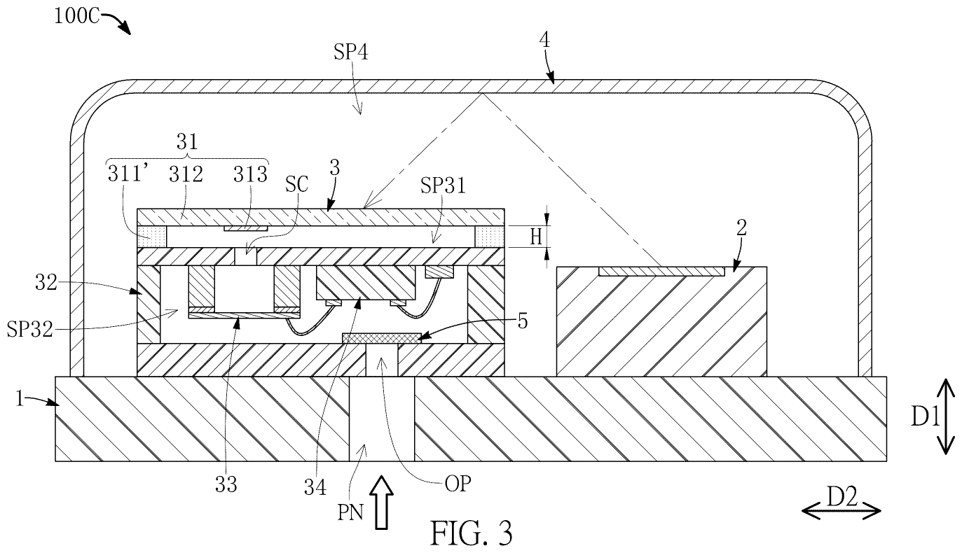

Referring to FIG. 3, a gas sensing device C of another embodiment of the present disclosure is similar to the gas sensing device 100A of the first embodiment, the same parts of the two embodiments will not be reiterated herein, and the main difference between the two embodiments is that a movement path of the gas firstly enters into the accommodation space SP32, passes through the sound channel SC, and then enters into the reaction space SP31. In other words, the movement path of the gas of the third embodiment is different from that of the gas of the first embodiment.

Specifically, in the present embodiment, the reflective cover 4 is provided without any openings, the surrounding wall 311′ is made of an airtight material, the accommodation chamber 32 has an opening OP for the entrance of the gas at one side thereof away from the reaction chamber 31. Naturally, the carrier board 1 also has a through hole PN that is in spatial communication with the opening OP. In addition, the air-permeable dustproof mesh 5 covers the opening OP, and the air-permeable dustproof mesh 5 is permeable for the gas to enter into the accommodation chamber 32. In a practical application, the air-permeable dustproof mesh 5 can be made of a material that is configured to block sound waves, so as to prevent the sound wave to be tested from escaping out of the photoacoustic spectroscopy gas sensor 3, or to prevent the photoacoustic spectroscopy gas sensor 3 from being affected by external sound waves.

### FOURTH EMBODIMENT

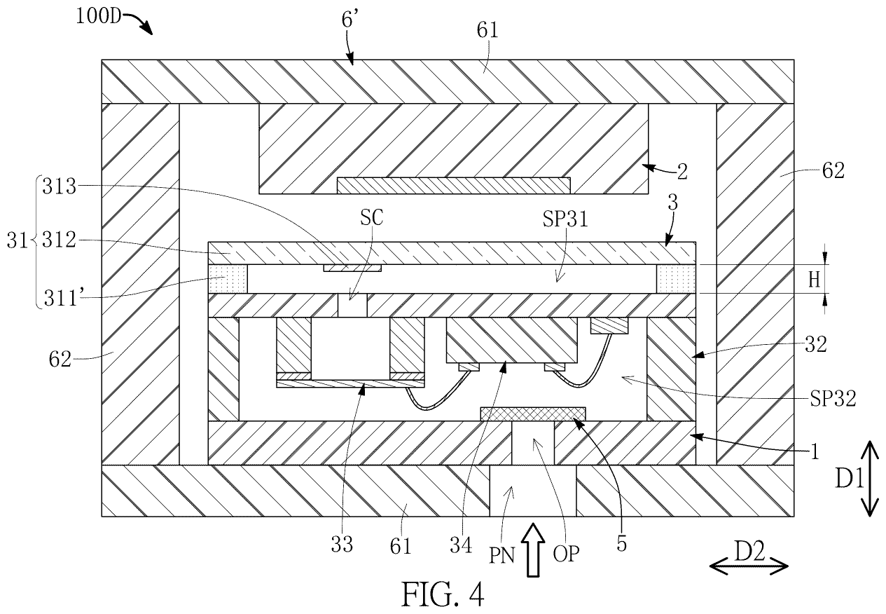

Referring to FIG. 4, a gas sensing device 100D of another embodiment of the present disclosure is similar to the gas sensing device 100C of the third embodiment, the same parts of the two embodiments will not be reiterated herein, and the main difference between the two embodiments is that the gas sensing device 100D of the present embodiment is provided without the carrier board 1, the reflective cover 4, and the air-permeable dustproof mesh 5, and the gas sensing device 100D includes a bracket 6′.

Specifically the bracket 6′ in the present embodiment has an enclosed structure. The bracket 6′ has two horizontal portions 61 and a vertical portion 62 connected to the two horizontal portions 61. Two side surfaces of the horizontal surfaces 61 facing toward each other are respectively defined as two arrangement surfaces, and the emitter 2 and the photoacoustic spectroscopy gas sensor 3 are respectively disposed at the two arrangement surfaces, such that the predetermined electromagnetic wave emitted by the emitter 2 is configured to directly pass through the light-transmittable cover 312. In other words, in the present embodiment, a path of the predetermined electromagnetic wave in the present embodiment directly passes through the light-transmittable cover 312.

### FIFTH EMBODIMENT

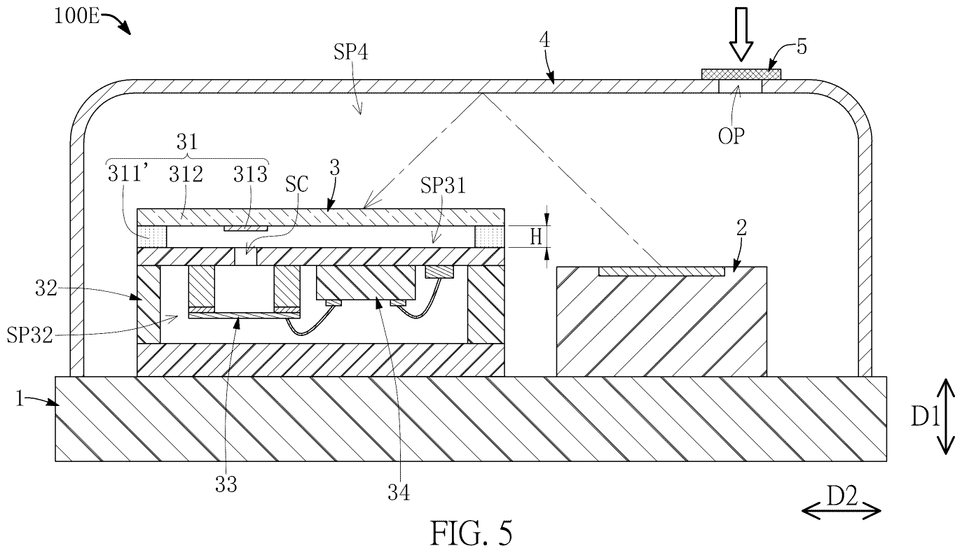

Referring to FIG. 5, a gas sensing device 100E of another embodiment of the present disclosure is similar to the gas sensing device 100A of the first embodiment, the same parts of the two embodiments will not be reiterated herein, and the main difference between the two embodiments is that the reaction chamber 31 is not in spatial communication with the enclosed space SP4 in the reflective cover 4.

Specifically, the surrounding wall 311′ in the present embodiment is made of an airtight material, such that the reaction space SP31 of the reaction chamber 31 is merely in spatial communication with the accommodation space SP32. In other words, the photoacoustic spectroscopy gas sensor 3 has an enclosed environment therein. In addition, a second gas is filled in the photoacoustic spectroscopy gas sensor 3 in advance.

In a practical application, a first gas is configured to pass through the air-permeable dustproof mesh 5 and enter into the enclosed space SP4. The first gas arranged in the enclosed space SP4 is configured to absorb one portion of the predetermined electromagnetic wave, and the second gas arranged in the reaction space SP31 is configured to absorb another portion of the predetermined electromagnetic wave. Accordingly, photoacoustic spectroscopy gas sensor 3 is configured to obtain a concentration of the first gas according to an attenuation amount. A material of the first gas can be the same as or different from that of the second gas.

### SIXTH EMBODIMENT

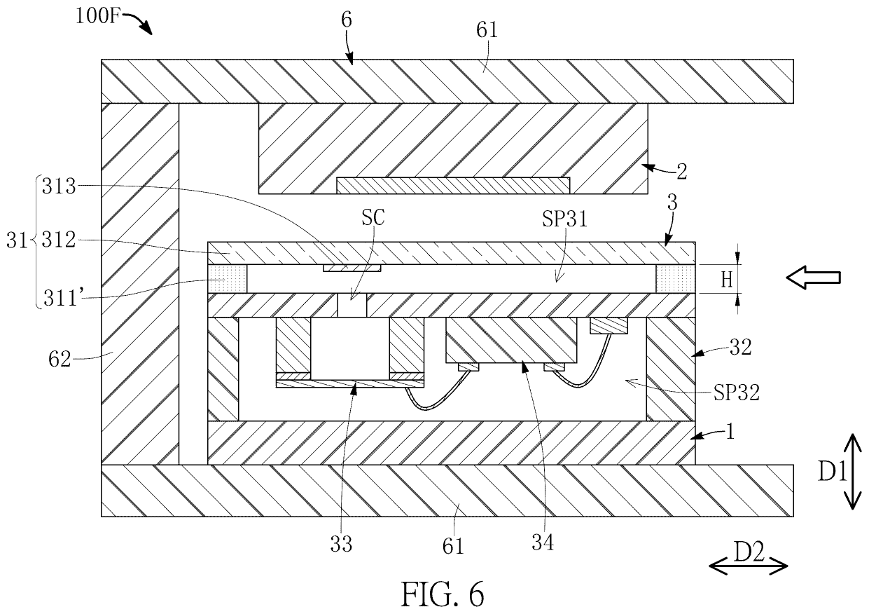

Referring to FIG. 6, a gas sensing device 100F of another embodiment of the present disclosure is similar to the gas sensing device 100B of the second embodiment, the same parts of the two embodiments will not be reiterated herein, and the main difference between the two embodiments is that the reaction chamber 31 is not in spatial communication with the enclosed space SP4 in the reflective cover 4.

Specifically, the surrounding wall 311′ in the present embodiment is made of an airtight material, such that the reaction space SP31 of the reaction chamber 31 is merely in spatial communication with the accommodation space SP32. In other words, the photoacoustic spectroscopy gas sensor 3 has an enclosed environment therein. In addition, a second gas is filled in the photoacoustic spectroscopy gas sensor 3 in advance.

In a practical application, the bracket 6 of the present embodiment has an open space, such that a first gas is configured to pass through a space between the emitter 2 and the photoacoustic spectroscopy gas sensor 3, the first gas is configured to absorb one portion of the predetermined electromagnetic wave, and the second gas in the reaction space SP31 is configured to absorb another portion of the predetermined electromagnetic wave. Accordingly, photoacoustic spectroscopy gas sensor 3 is configured to obtain a concentration of the first gas according to an attenuation amount. A material of the first gas can be the same as or different from that of the second gas.

### Beneficial Effects of the Embodiments

In conclusion, in the gas sensing device and photoacoustic spectroscopy gas sensor provided by the present disclosure, by the design of “the accommodation chamber and the reaction chamber jointly having the sound channel that is in spatial communication with the accommodation space and the reaction space” and “the microelectromechanical system unit being disposed in the accommodation chamber and covering the sound channel, such that the sound wave to be tested is configured to be directly tested by the microelectromechanical system unit,” the gas sensing device and photoacoustic spectroscopy gas sensor can timely and accurately test the sound wave to be tested.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A gas sensing device, comprising:
an emitter configured to emit a predetermined electromagnetic wave; and
a photoacoustic spectroscopy gas sensor disposed at one side of the emitter, the photoacoustic spectroscopy gas sensor including:
a reaction chamber having a reaction space configured to accommodate a gas; wherein the predetermined electromagnetic wave is configured to pass through the reaction chamber and enter into the reaction space, such that the gas and the predetermined electromagnetic wave generate a sound wave to be tested;
an accommodation chamber connected to the reaction chamber; wherein the accommodation chamber has an accommodation space, the accommodation chamber and the reaction chamber jointly have a sound channel, and the sound channel is in spatial communication with the accommodation space and the reaction space;
a microelectromechanical system unit disposed in the accommodation chamber and covering the sound channel, such that the sound wave to be tested is configured to be directly tested by the microelectromechanical system unit; and
an application-specific integrated circuit connected to the microelectromechanical system unit.

2. The gas sensing device according to claim 1, wherein the reaction chamber includes a surrounding wall and a light-transmittable cover, the surrounding wall is disposed on the accommodation chamber and covered by the light-transmittable cover, and the light-transmittable cover is configured for the predetermined electromagnetic wave to pass through.

3. The gas sensing device according to claim 2, wherein the reaction chamber further includes an electromagnetic wave mask, one side surface of the light-transmittable cover facing toward the accommodation chamber has a predetermined region, the predetermined region is located at an orthographic projection path formed by orthographically projecting the sound channel along a height direction, and the electromagnetic wave mask is arranged in the predetermined region.

4. The gas sensing device according to claim 3, wherein a projection region formed by orthographically projecting the electromagnetic wave mask along the height direction on the accommodation chamber covers the sound channel.

5. The gas sensing device according to claim 2, wherein the surrounding wall is made of an air-permeable material, and the gas is configured to pass through the surrounding wall and enter into the reaction space.

6. The gas sensing device according to claim 5, further comprising a carrier board and a reflective cover; wherein the reflective cover, the emitter, and the photoacoustic spectroscopy gas sensor are disposed on the carrier board, the emitter and the photoacoustic spectroscopy gas sensor are covered by the reflective cover, and the predetermined electromagnetic wave emitted by the emitter is configured to be reflected by the reflective cover and to pass through the light-transmittable cover.

7. The gas sensing device according to claim 6, wherein one side of the reflective cover away from the photoacoustic spectroscopy gas sensor has an opening; and wherein the gas sensing device further includes an air-permeable dustproof mesh covering the opening, and the air-permeable dustproof mesh is permeable for the gas to enter from an outer side of the reflective cover into an inner side of the reflective cover.

8. The gas sensing device according to claim 5, further comprising a bracket; wherein the bracket has two arrangement surfaces facing toward each other, the emitter and the photoacoustic spectroscopy gas sensor are respectively arranged at the two arrangement surfaces, and the predetermined electromagnetic wave emitted by the emitter is configured to directly pass through the light-transmittable cover.

9. The gas sensing device according to claim 2, wherein the surrounding wall is made of an airtight material, and one side surface of the accommodation chamber away from the reaction chamber has an opening; and wherein the gas sensing device further includes an air-permeable dustproof mesh covering the opening, and the air-permeable dustproof mesh is permeable for the gas to enter into the accommodation chamber.

10. The gas sensing device according to claim 9, further comprising a carrier board and a reflective cover; wherein the reflective cover, the emitter, and the photoacoustic spectroscopy gas sensor are disposed on the carrier board, the emitter and the photoacoustic spectroscopy gas sensor are covered by the reflective cover, and the predetermined electromagnetic wave emitted by the emitter is configured to be reflected by the reflective cover and to pass through the light-transmittable cover.

11. The gas sensing device according to claim 9, further comprising a bracket;
wherein the bracket has two arrangement surfaces facing toward each other, the emitter and the photoacoustic spectroscopy gas sensor are respectively arranged at the two arrangement surfaces, and the predetermined electromagnetic wave emitted by the emitter is configured to directly pass through the light-transmittable cover.

12. The gas sensing device according to claim 2, wherein a minimum predetermined gap is defined between the light-transmittable cover and one side surface of the accommodation chamber facing toward the light-transmittable cover, and the minimum predetermined gap is between 0.1 mm and 1 mm.

13. The gas sensing device according to claim 1, wherein a wavelength of the predetermined electromagnetic wave is 4.26 μm, and a frequency of the predetermined electromagnetic wave is between 10 Hz and 200 Hz.

14. The gas sensing device according to claim 2, further comprising a carrier board and a reflective cover; wherein the reflective cover is disposed on the carrier board to form an enclosed space, and the emitter and the photoacoustic spectroscopy gas sensor are disposed in the enclosed space; and wherein the surrounding wall is made of an airtight material, the reaction space and the accommodation space are not in spatial communication with the enclosed space, the enclosed space is configured to be filled with a first gas to absorb one portion of the predetermined electromagnetic wave, and the reaction space is configured to be filled with a second gas to absorb another portion of the predetermined electromagnetic wave.

15. The gas sensing device according to claim 8, wherein the surrounding wall is made of an airtight material, the reaction space and the accommodation space are not in spatial communication with an opening space of the bracket, the opening space is configured to be filled with a first gas to absorb one portion of the predetermined electromagnetic wave, and the reaction space is configured to be filled with a second gas to absorb another portion of the predetermined electromagnetic wave.

16. A photoacoustic spectroscopy gas sensor, comprising:
a reaction chamber having a reaction space configured to accommodate a gas; wherein a predetermined electromagnetic wave is configured to pass through the reaction chamber and enter into the reaction space, such that the gas and the predetermined electromagnetic wave generate a sound wave to be tested;
an accommodation chamber connected to the reaction chamber;
wherein the accommodation chamber has an accommodation space, the accommodation chamber and the reaction chamber jointly have a sound channel, and the sound channel is in spatial communication with the accommodation space and the reaction space;
a microelectromechanical system unit disposed in the accommodation chamber and covering the sound channel, such that the sound wave to be tested is configured to be directly tested by the microelectromechanical system unit; and
an application-specific integrated circuit connected to the microelectromechanical system unit.
